(19) United States
(12) Patent Application Publication
(10) Pub. No.: US 2011/0198302 A1
(43) Pub. Date: Aug. 18, 2011

(54) Floating marine debris trap

(76) Inventors: Theodore Griffith, Encinitas, CA (US); Richard Joseph Hebert, II, San Diego, CA (US); Roger Dean Taylor, San Marcos, CA (US)

(21) Appl. No.: 12/658,401

(22) Filed: Feb. 12, 2010

(51) Int. Cl. C02F 1/40; B01D 17/12

(52) U.S. Cl. 210/776; 210/121

(57) ABSTRACT

A system for capturing and containing waterborne floating debris in bays, harbors, rivers, and other waterways with current, tidal, or wind action flow. This system utilizes a hinged capture gate attached to any of the commercially produced oil slick containment boom systems along with an anchoring deployment that orients the debris trap perpendicular to current, prevailing wind, and tidal flow in employed waterways. The door frame/door gate invention along with the alignment and anchoring of the boom material will allow floating debris to be captured and held within the boom material for later collection and disposal or recycle. This system allows mandated oil slick boom to serve the extended purpose of collecting floating debris before it enters the open oceans and inland waterways. Thousands of yards of oil slick boom are in place that could be utilized to catch and contain waterborne trash and valuable recyclables in every coastal bay, harbor, and waterway worldwide. Removal of floating debris from the debris trap is accomplished with a small boat or skiff and a dip net. This trash may be collected for disposal by municipal agencies that both recycle, remove and (or) compost land borne waste.

### BACKGROUND OF THE INVENTION

The recent discovery of a major Pacific Ocean current break containing one thousand square miles of floating debris and the inundation of beaches with trash in the Hawaiian Island chain delineates the need to capture, contain, and remove waterborne debris that originates from land sources. Known as the “Pacific Gyre” or “Great Pacific Garbage Patch”; It is said that each ocean has a gyre and another debris vortex may be forming in the Atlantic Ocean.1 Scientific studies of the debris field located in the Eastern Pacific Ocean have determined that certain classes of marine trash have negative effects on both pelagic and local marine wild life.2 While states and countries enact laws to promote conservation of marine resources, the proliferation of ocean and waterway debris is causing unknown but suspicious negative effects on worldwide marine resources. The obvious solution to the vast trash pile in our ocean and resultant water pollution is to collect the floating debris before it leaves local coastlines. One part of the solution is to collect floating debris in sheltered coastline areas using a trap-type device. This invention is a passive system that adds a debris collection function to the already mandated oil slick collection booms in place around most industrial marine installations.

Literature cited

1. Pitchel, W., J. Churnside, T Veenstra, D. Foley, K Friedman, R Brainard, J. Nicoll, Q Zheng, andP. Clemente-Colon. 2007 Marine Debris Collects Within the Noth Pacific Subtropical Zone. Marine Pollution Bulletion 54:1207-1211

2. Donohue, M and D. Foley. 2007. Remote Sensing Reveals Links Among the

Endangered Hawaiian Monk Seal, Marine Debris, and El Nino. Marine Mammal Scienc 23(2):468-473

3. Office of Response and Restoration.2008 Marine Debris, De-mystifying the “Great Pacific Garbage Patch” National Ocean and Atmospheric Association

### BRIEF SUMMARY OF THE INVENTION

The invention features a system for containing water born debris for removal to sanctioned disposal facilities. The principle member of the invention is a door frame/door assembly, DFD that is installed between one or more oil slick containment boom The DFD assembly along with several boom deployment configurations results in a collection/containment system suited to various water conditions and marine structures.

Accumulated debris may be collected by boat or from structures and disposed of in local sanctioned facilities. In the preferred embodiment of the system, either existing oil slick boom arrays or new DFD/boom arrays would be placed at locations of natural tidal , current, or wind action flow.

### BRIEF DESCRIPTION OF THE DRAWINGS

FIG. 1 is a 2 view diagram of the side hinged DFD assembly and with cut-awy sections of oil containment boom connected at both sides.

FIG. 2 is an example of the offset vertical door pivot of the arrangement of one DFD application. The open door also acts as a diverter to rout debris into the containment area.

FIGS. 3 & 4 depict two top hinged DFD arrangements, one with a fixed door and the other with vertical skirted vinyl strips with lower weights.

FIG. 5 depicts a deployment method with two DFD's configured with boom and anchoring points. This array is designed to capture debris from two directional changes of water flow.

FIG. 6 shows the DFD/boom system deployed adjacent to a storm drain outfall pipe.

FIG. 7 shows the DFD/boom applied to marine structures such as piers, docks or terminals.

FIG. 8 shows the flexibility of deployment configurations when known areas of debris accumulation are identified.

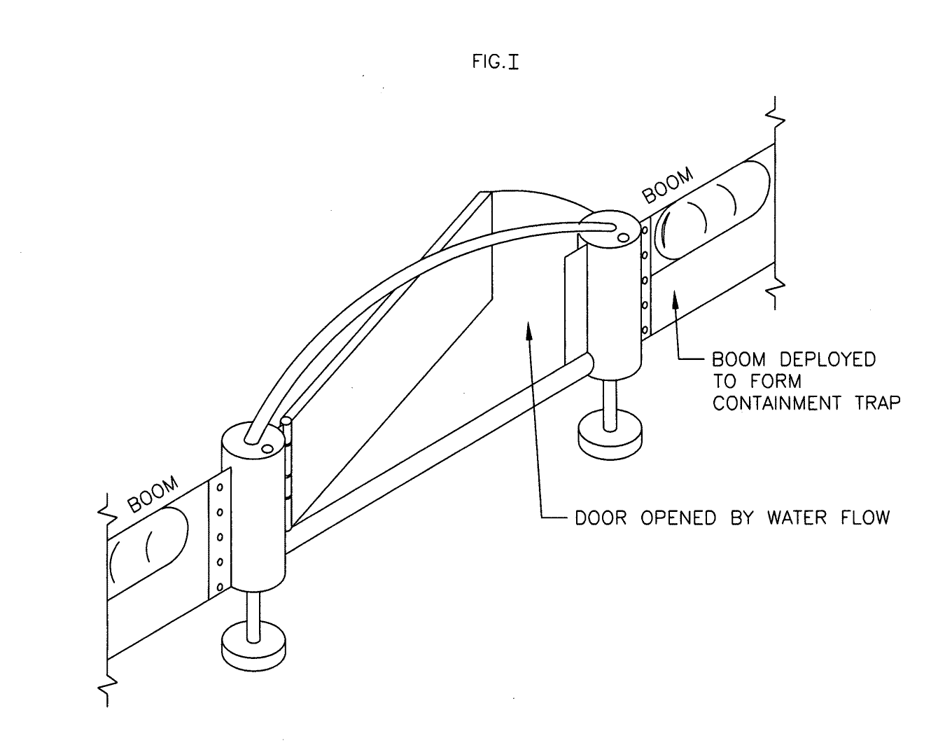

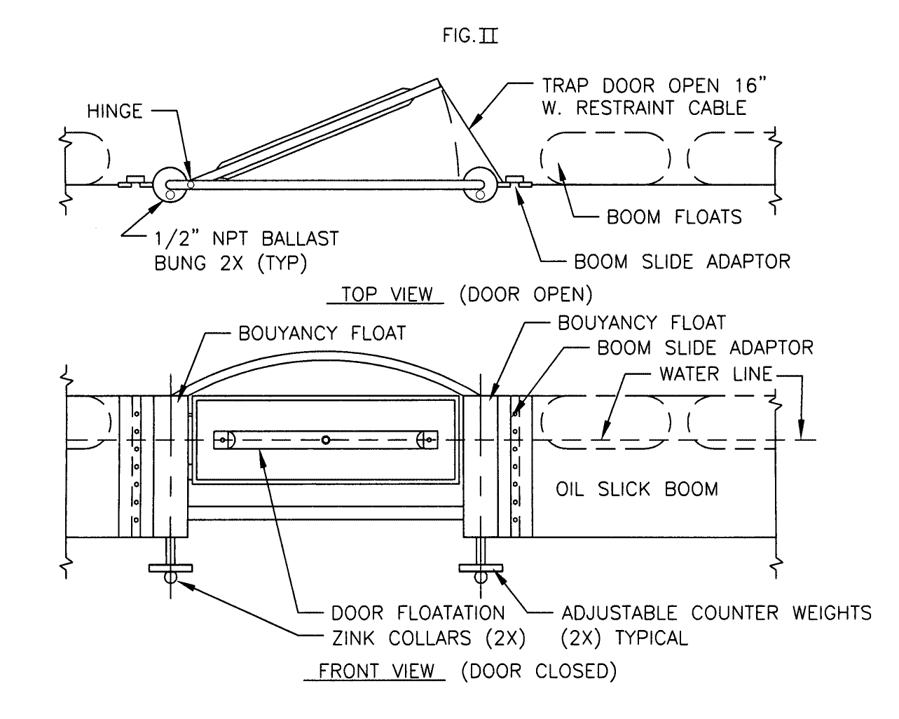

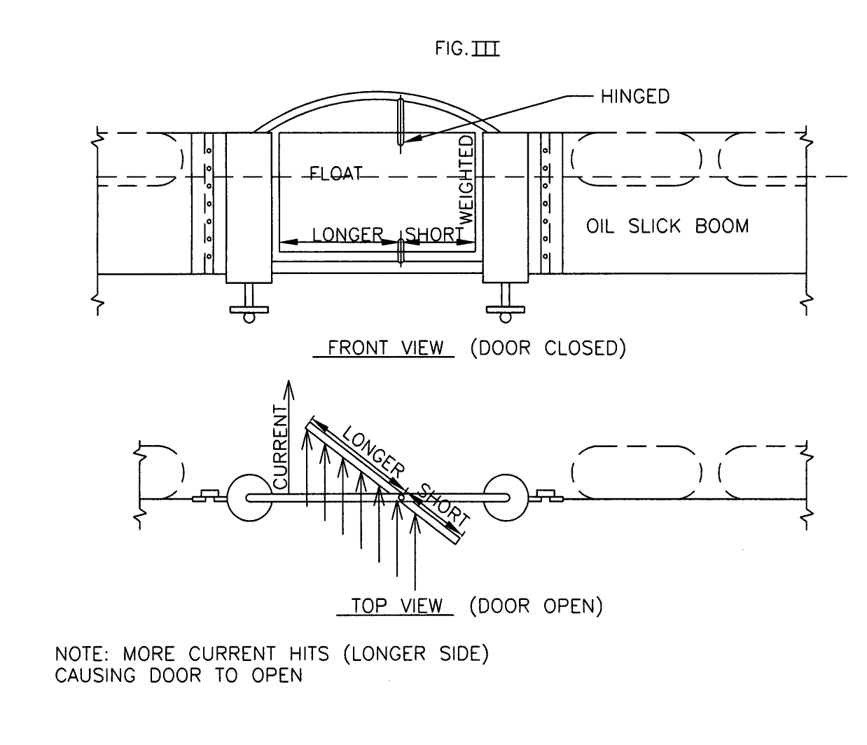

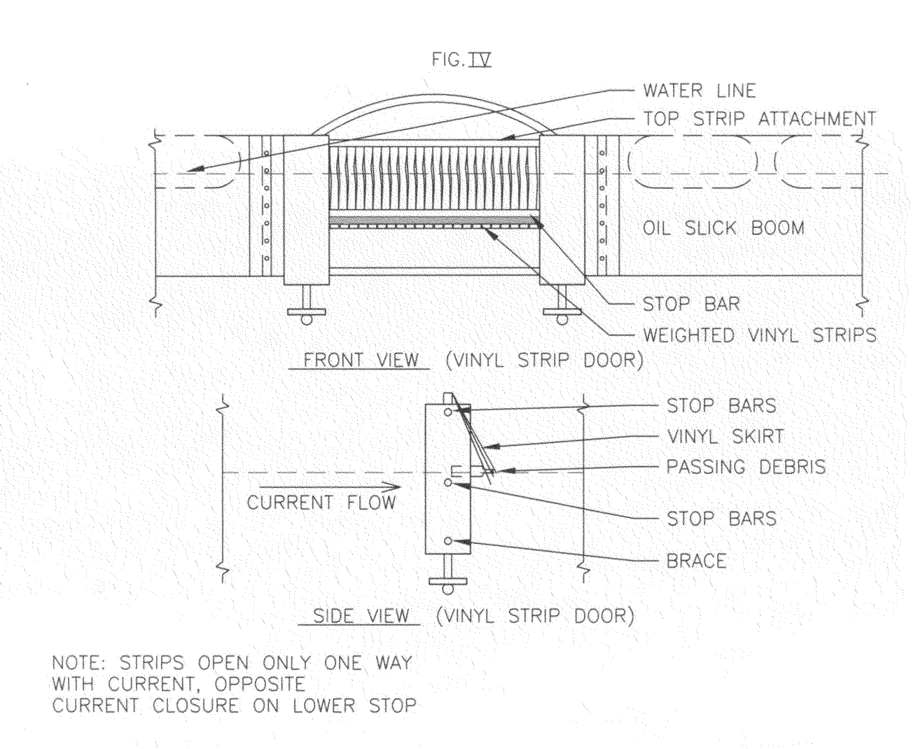

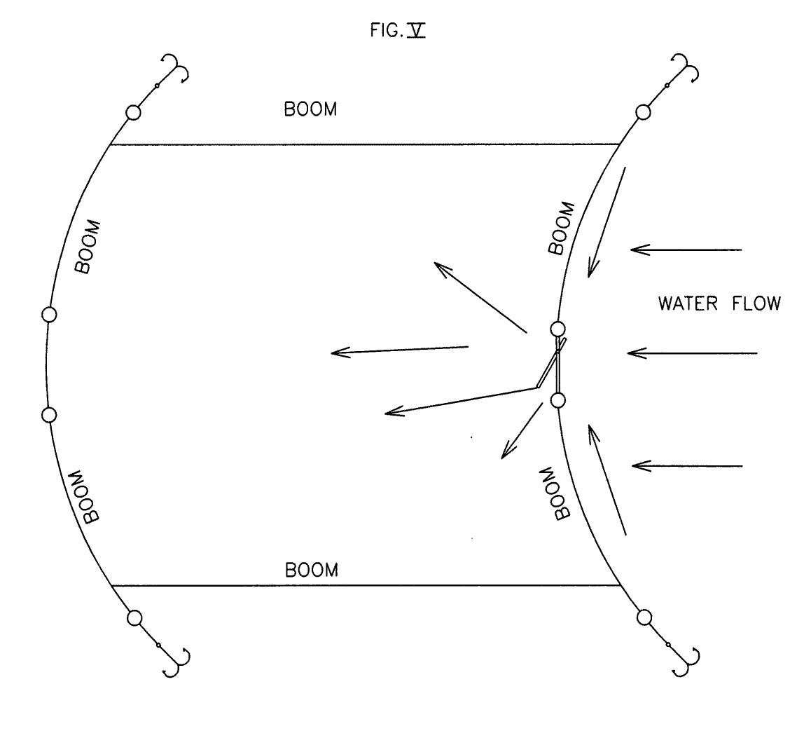

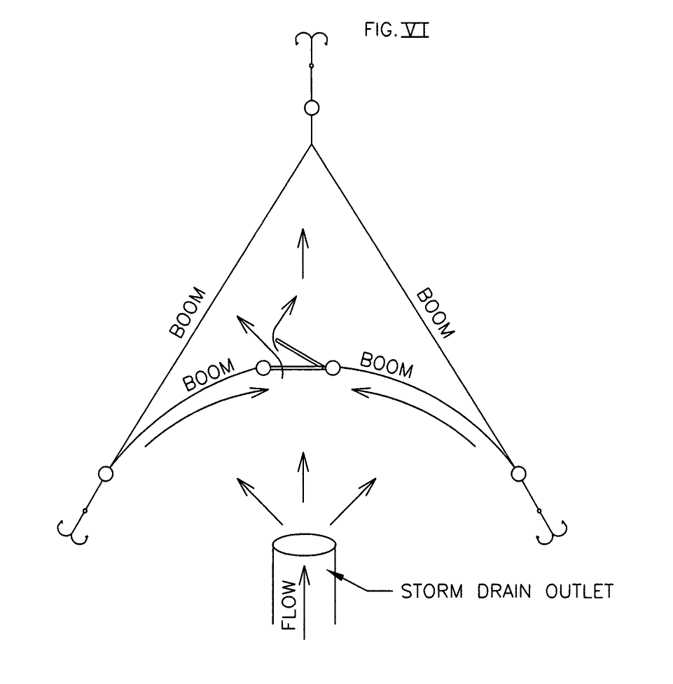

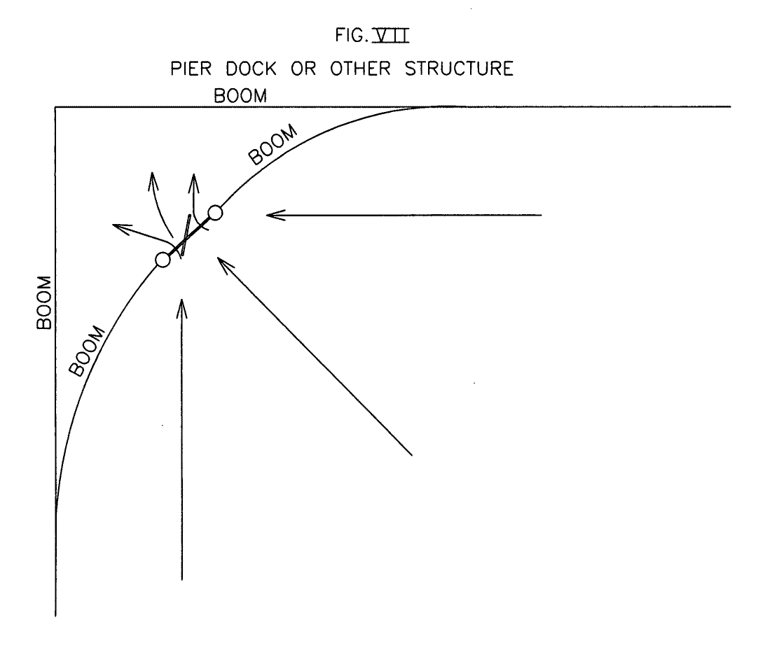

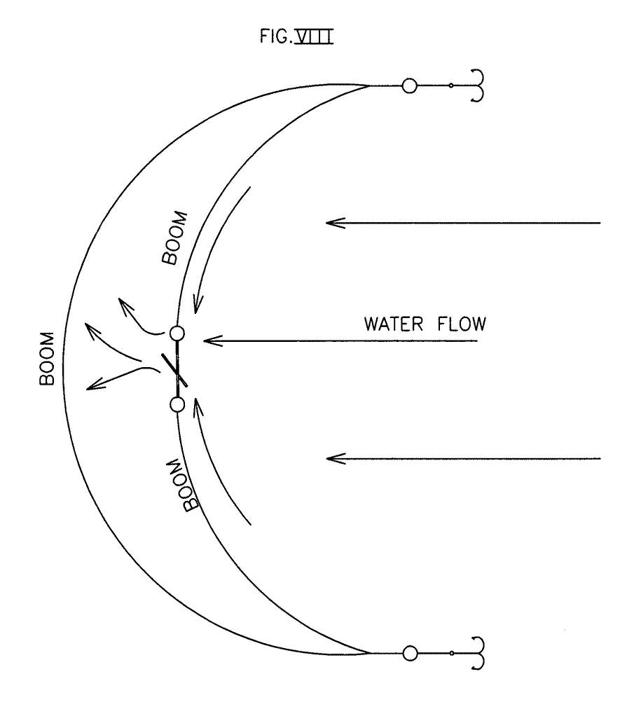

### DETAILED DESCRIPTION

The floating marine debris trap is a combination of a door frame/door assembly connected to commercial oil slick containment boom. The invention is a combination of a unique floating door frame/door assembly and a series of oil slick boom deployment methods that form the floating marine debris trap. Regularly available commercial oil slick containment boom combined with various types of door frame/door entry systems and specific deployment methods will trap both oil based water contaminants and floating debris. Trapped aquatic debris may be returned to the water or disposed or per local, state and federal regulations. Four different door configurations are cited as examples of adapting the debris trap opening to the correct conditions of tidal flow, current, and (or) wind action. The diagrams #1-#4 depict the standard door frame and the different door configurations. Utilizing the various deployment methods, floating marine debris may be contained and collected for commercial disposal, recycle, and (or) reuse. This passive system utilizes current, tidal flow, and (or) wind action to move water into the deployed containment device. The door frame/door assembly opens and closes with water movement and floating debris moves into the containment boom for later removal. The hinged trap door moves freely with water flow. The door hinges open inward into the containment area and remains open as long as water flow is relatively perpendicular to the debris trap door alignment. Once the current or water movement shifts to an opposite direction, the door closes and does not allow debris to escape. Door seals and (or)spring door closures restrict floating liquids from leaving the containment area.

Buoyancy tanks are attached at opposite sides of the door frame. The buoyancy tanks are utilized to keep the assembly suspended at the same level as the attached commercial oil slick boom. These tanks may be ballasted with water to trim the door/frame assembly and keep the debris entry area at the same level as the oil slick boom. The door and frame assembly is installed by bolting the sides between two or more sections of commercial oil slick containment boom. Adaptor plates for every oil slick boom are produced by the boom manufacturers. These plates are bolted to the sides of the buoyancy tanks to provide easy adaptability to equipment that is on hand. The DFD assembly may be easily removed for cleaning or other maintenance by sliding it out of the boom adaptor plates. .The DFD assembly may be constructed of aluminum, fiberglass, or other thermosetting plastic/ Composite materials The summary, claim section gives several possible deployment configurations and applications. Many harbors, bays, and inland waterways have natural eddies or places where floating debris collects naturally. The Floating marine trash trap will accentuate the capture of floating debris at these natural points of concentration. The floating debris will have to be removed manually by personnel in boats and some form of debris removal tool or net. This function will presumably be the responsibility of the owner or lessee of ocean front or inland waterway real estate.

1. This invention applies to any gate, diverter, or inlet assembly that in combination with commercial oil slick boom is specifically designed to capture floating marine debris. The primary distinctive feature of this invention is a floating door frame and freely hinged door DFD that forms a gate or inlet to the debris trap. The door opens and closes freely with tidal action allowing floating debris to enter with one direction of tidal current and closes for containment when the tide changes direction. This action leaves debris trapped within the walls of the containment boom and allows debris-free water to flow from the bottom of the containment. Two of the door frame/door assemblies in conjunction with one or more oil containment boom sections will allow the capture of debris from two directions of tidal motion as well as wind borne floating debris capture thus maximizing the efficiency of the system. This is the deployment method that maximizes surface water /debris contact with the entrapment device.

2. This invention also applies to the deployment of oil slick containment boom with the DFD in place and the specific configuration to capture marine debris. Two of the door frame/door assemblies in conjunction with one or more oil containment boom sections will allow the capture of debris from two directions of tidal motion as well as wind borne floating debris capture thus maximizing the efficiency of the system. This is the deployment method that maximizes surface water/debris contact with the entrapment device. The deployment of the oil containment slick boom with two floating door frame units requires fixed anchoring at the extreme end (s) of the boom. This may be accomplished with commercial boat-type anchors or by tethering to existing fixed objects. A taught center boom of various lengths would be anchored in an orientation that is perpendicular to typical current, tidal flow, or prevailing wind direction. A two boom system with one floating door/frame assembly may be situated in front of all land storm drain water entry points to bays, lagoons, and harbors. A typical installation would result in a system with one anchored boom/door unit deployed in an arc in front of the outfall and a containment boom attached at the same anchor point in a fashion wherein the boom floats in a larger arc behind the door entry point and provides containment for the floating debris. Docks and piers with vertical access may be wrapped in containment boom with the floating door/frame assembly in place at the point of maximum current or tidal flow. Marine fuel stations are situated in most harbors and the addition of the floating door/frame assembly to mandated oil containment booms gives a new debris collection function to the deployment of these environmental protection devices. A single door/frame assembly attached between one section of containment boom may be deployed in circular, oval, or irregular shaped to fit the specific area of debris collection. The flexibility of the boom material provides unlimited deployment options for areas requiring floating debris capture.
